(19) United States
(12) Patent Application Publication
(10) Pub. No.: US 2020/0178562 A1
(43) Pub. Date: Jun. 11, 2020

(54) FROZEN DESSERT AND METHOD OF MAKING AND PACKAGING THE SAME

(71) Applicant: Nicholas Di Bona, Larchmont, NY (US)

(72) Inventor: Nicholas Di Bona, Larchmont, NY (US)

(21) Appl. No.: 16/704,545

(22) Filed: Dec. 5, 2019

Related U.S. Application Data
(60) Provisional application No. 62/775,646, filed on Dec. 5, 2018.

(51) Int. Cl. A23G 9/48; A23G 9/40; A23G 9/34; A23G 9/38; A23G 9/08; A23G 9/32

(52) U.S. Cl. CPC A23G 9/48; A23G 9/40; A23G 9/34; A23V 2002/00; A23G 9/08; A23G 9/322; A23G 9/38

(57) ABSTRACT

A frozen dessert includes a gelato layer and a meringue layer positioned on top of the gelato layer, wherein the meringue layer is heater to harden and color a top surface thereof. A method of making and packaging the frozen dessert includes making gelato for a gelato layer of the frozen dessert, adding the gelato to the container, placing the container and gelato in a blast chiller, making meringue for a meringue layer of the frozen dessert, adding the meringue layer on top of the gelato layer in the container and heating the meringue layer.

### CROSS-REFERENCE TO RELATED APPLICATIONS

The present application claims benefit of and priority to U.S. Provisional Patent Application Ser. No. 62//775,646 filed Dec. 5, 2018 entitled FROZEN DESSERT AND METHOD OF MAKING AND PACKAGING THE SAME, the entire content of which is hereby incorporated by reference herein.

### BACKGROUND

### Field of the Disclosure

The present invention relates to a frozen dessert. In particular, the present invention is directed to a frozen dessert including a meringue topping that is torched in place on a gelato base and a method of making and packaging the same.

### Related Art

Ice cream, including prepackaged ice cream desserts, is popular and commonly available. While such desserts are well liked, they are somewhat limited in the depth of flavor that can be provided and the types of toppings that can be provided. Accordingly, it would be beneficial to provide a frozen dessert that avoids these and other problems.

### SUMMARY

It is an object of the present disclosure to provide a frozen dessert that includes a gelato base and an Italian meringue top layer, where the meringue topping is torched.

A method of making and packaging a frozen dessert in accordance with an embodiment of the present disclosure includes: making gelato for a gelato layer of the frozen dessert, adding the gelato to the container, placing the container and gelato in a blast chiller, making meringue for a meringue layer of the frozen dessert, adding the meringue layer on top of the gelato layer in the container; and heating a top surface of the meringue layer.

In embodiments, the method includes steps of: adding a lid to the container after the heating step and placing the container with the lid in a storage freezer.

In embodiments, the step of making gelato further includes steps of: combining a flavoring agent with cream, blending a stabilizer and milk into the cream, adding sugar to the stabilizer, cream and milk mixture, adding salt to the stabilizer, cream and milk mixture and churning and cooling the stabilizer, cream and milk mixture.

In embodiments, the flavoring agent includes a plurality of vanilla bean pods.

In embodiments, the step of making gelato further includes a step of heating the flavoring agent and cream prior to the step of blending the stabilizer and milk into the cream.

In embodiments, the step of churning and cooling takes place in an ice cream machine.

In embodiments, the step of making meringue includes: combining a plurality of egg whites into an egg white mixture, whisking the egg white mixture, adding cream of tartar to the whisked egg white mixture, adding sugar to the whisked egg white mixture, combining sugar with an amount of water, heating the sugar and water mixture to a desired temperature, pouring the heated sugar and water mixture into the whisked egg white mixture and beating the resulting mixture to a desired consistency.

In embodiments, the step of combining sugar with the amount of water takes place before the step of combining the plurality of egg whites into an egg white mixture.

In embodiments, the step of combining sugar with the amount of water takes place at the same time as the step of combining the plurality of egg whites into an egg white mixture.

In embodiments, the step of combining sugar with the amount of water takes place before the steps of whisking, adding cream of tartar and adding sugar.

In embodiments, the step of combining sugar with the amount of water takes place at the same time as at least one of the steps of whisking, adding cream of tartar and adding sugar.

In embodiments, the step of combining sugar with an amount of water takes place between at least two of the steps of whisking, adding cream of tartar and adding sugar.

In embodiments, the steps of combining sugar with an amount of water and heating the sugar and water mixture take place before the step of combining the plurality of egg whites into the egg white mixture.

In embodiments, the steps of combining sugar with an amount of water and heating the sugar and water mixture take place at the same time as the step of combining the plurality of egg whites into the egg white mixture.

In embodiments, the steps of combining sugar with an amount of water and heating the sugar and water mixture take place before the steps of whisking, adding crème of tartar and adding sugar.

In embodiments, the steps of combining sugar with an amount of water and heating the sugar and water mixture take place at the same time as at least one of the steps of whisking, adding crème of tartar and adding sugar.

In embodiments, the steps of combining sugar with an amount of water and heating the sugar and water mixture take place in between one or more of the steps of whisking, adding crème of tartar and adding sugar.

A frozen dessert in accordance with an embodiment of the present disclosure includes a gelato layer and a meringue layer positioned on top of the gelato layer, wherein a top surface of the meringue layer is heated to harden and char the top surface.

In embodiments, the meringue layer includes Italian meringue.

### BRIEF DESCRIPTION OF THE DRAWINGS

The above and related objects, features and advantages of the present disclosure will be more fully understood by reference to the following, detailed description of the preferred, albeit illustrative, embodiment of the present invention when taken in conjunction with the accompanying figures, wherein:

FIG. 1 illustrates an exemplary container with a frozen dessert that includes a gelato base layer and a meringue top layer in accordance with an embodiment of the present application;

FIG. 2 illustrates another view of the container and frozen dessert of FIG. 1 showing both the base gelato layer and the meringue top layer in accordance with an embodiment of the present application;

FIG. 3 illustrates an exemplary cross section of the container and frozen dessert of FIGS. 1 and 2;

FIG. 4 illustrates a flow chart including exemplary method steps for making and packaging the frozen dessert of FIGS. 1 and 2 in the container in accordance with an embodiment of the present application;

FIG. 5 illustrates a flow chart including exemplary method steps for making gelato for the gelato layer of the frozen dessert of FIGS. 1 and 2 in accordance with an embodiment of the present application;

FIG. 6 illustrates a flow chart including exemplary method steps for making meringue for the meringue layer of the frozen dessert of FIGS. 1 and 2 in accordance with an embodiment of the present application;

FIG. 7 illustrates a frozen dessert in accordance with an embodiment of the present application provided in an ice cream cone; and

FIG. 8 illustrates a frozen dessert in accordance with an embodiment of the present application provided in an ice cream cup.

### DETAILED DESCRIPTION OF THE EXEMPLARY EMBODIMENTS

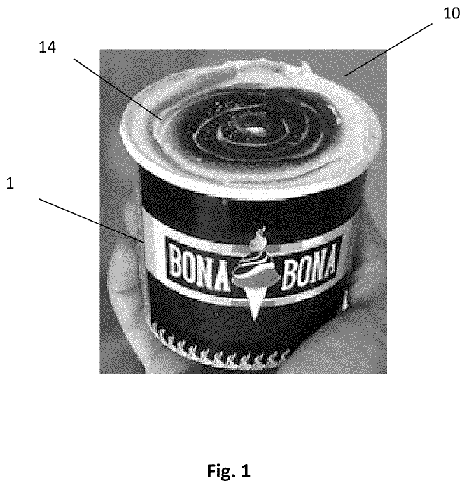

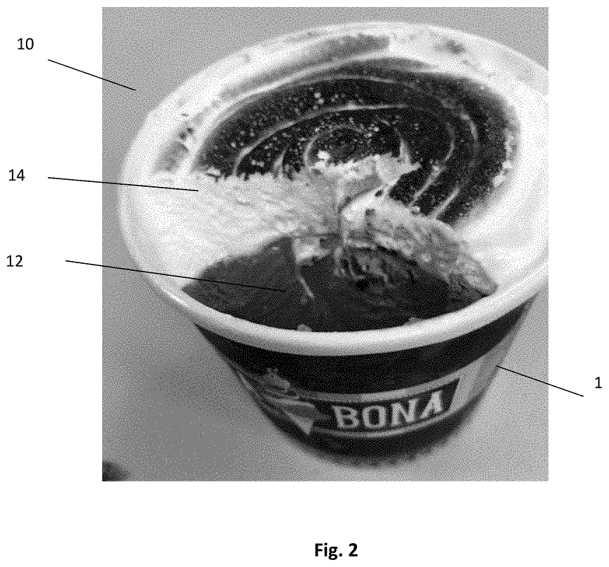

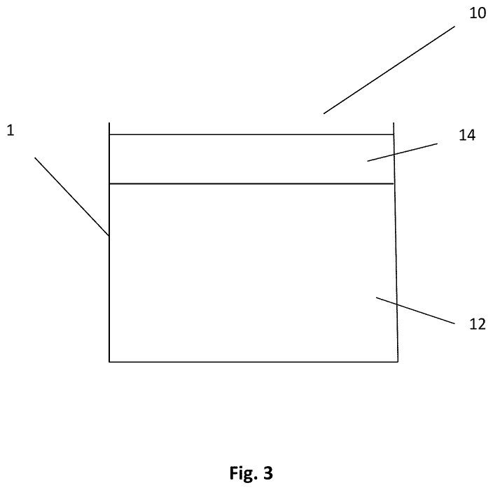

FIG. 1 illustrates a container 1 with a frozen dessert 10 in accordance with an embodiment of the present disclosure. In embodiments, as can be seen in FIGS. 2-3, the frozen dessert 10 includes a base gelato layer 12 with a meringue layer 14, which may be made of or include Italian meringue, layered on top of the base gelato layer 12. The term “gelato” as used herein is interchangeable with the term “ice cream” and the gelato layer 12 may be made of gelato, ice cream or a combination of the two. The term Italian meringue is used herein to refer to meringue made in an Italian style, however, the meringue layer 14 may be made of, or include, Italian meringue or any other meringue. In embodiments, as can be seen in FIGS. 1-2, the meringue layer 14 may be torched, or otherwise heated, to provide a golden char on an outer surface thereof. In embodiments, the outer surface may be heated using a kitchen blow torch, however, may be heated using other implements, if desired. Subjecting meringue to heat in this manner hardens the outer surface thereof to provide for a crunchy texture as well as golden or charred appearance.

In embodiments, the base gelato layer 12 fills about 80% of the container 1, while the meringue layer 14 fills the remaining 20% of the container. In embodiments the gelato layer 12 may fill as little as 70% of the container 1 and as much as 90% of the container, and the meringue layer 14 may fill as little as 10% of the container and as much as 30% of the container.

In embodiments, the container 1 may accommodate a total volume of 16 oz., however, the container may be provided in other sizes (e.g. 8 oz., 32 oz., 64 oz., to name a few). In embodiments, the container 1 may be substantially filled with gelato and meringue, however, a small space may be left at a top of the container 1, if desired, as can be seen in FIG. 3, for example.

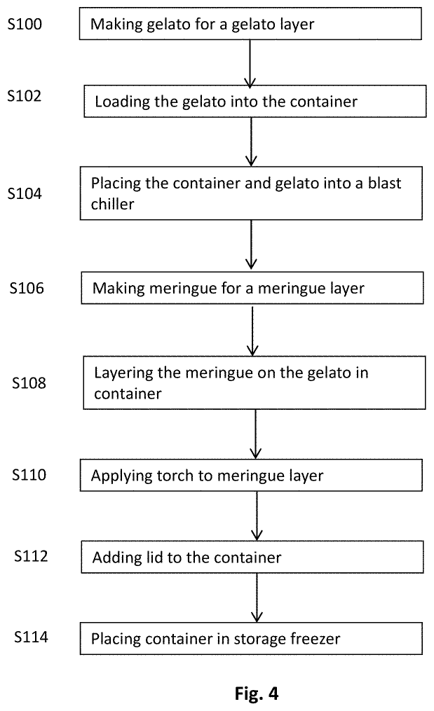

FIG. 4 illustrates a flowchart illustrating exemplary steps for making and packaging the frozen dessert 10 in the container 1. In embodiments, at a step S100, the gelato for the gelato layer 12 is made. In embodiments, at step S102, the gelato is loaded into the container 1 to provide the gelato layer 12. In embodiments, at step S104, the container 1 with the gelato layer 12 is placed in a blast chiller (not shown). In embodiments, at step S106, the meringue for the meringue layer 14 may be made. In embodiments, in step S108, the Italian meringue may be layered on top of the gelato layer 12 in the container 1 to provide the meringue layer 14. In embodiments, the container with the gelato layer 12 may be removed from the blast chiller prior to step S108. In embodiments, step S108 may take place with the container in the blast chiller. As noted above, Italian meringue may be or include any type of meringue. In embodiments, the meringue may be piped onto the gelato layer 12 to provide the meringue layer 14. At step S110, the top surface of the meringue layer 14 is torched, or otherwise heated, to brown and harden just the top surface of the meringue layer. In embodiments, the container 1 with the gelato 12 and meringue 14 may be removed from the blast chiller before step 110. In embodiments, step S110 may take place without removal of the container 1 from the blast chiller. At step S112, a lid may be placed on the container 1. In embodiment, the container 1 with the gelato 12 and meringue 14 may be removed from the blast chiller before step S112. In embodiments, the lid may be applied while the container 1 with the gelato 12 and meringue 14 is in the blast chiller. At step S114, the container 1 may be placed in a storage freezer and stored for later consumption. In embodiments, steps S112 and S114 may not be necessary, for example, where that the frozen dessert 10 will be eaten right away such that storage is unnecessary. In embodiments, where the frozen desert is being served immediately, it may not be necessary to perform step S104. In embodiments, the step of preparing the meringue at step S106 may be performed before, at the same time as or after, the step of preparing the gelato at step S100. In embodiments, the step of preparing the meringue at step S106 may take place before, at the same time as, or between any of the steps S102-S104.

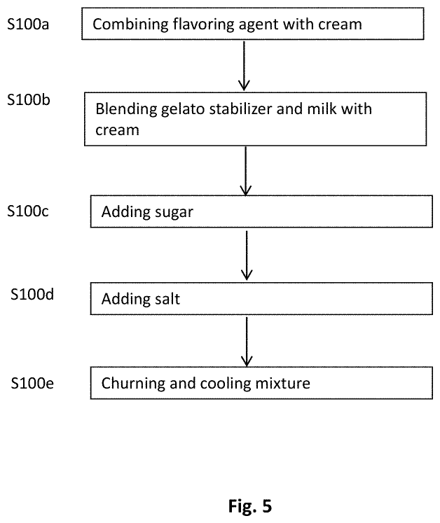

FIG. 5 illustrates a flowchart illustrating exemplary steps for making the gelato in step S100. In embodiments, at step S100a, a flavoring agent is combined with cream. In one example, the flavoring agent may be vanilla bean pods, however, other flavoring agents may be used to provide a desired flavor for the gelato. In embodiments, the cream and flavoring agent may be heated, for example when the flavoring agent is vanilla bean pods, such that the flavoring agent will steep in the cream to infuse flavor. In embodiments, at step S100b, a gelato stabilizer and milk may be blended into the cream. In embodiments, at step S100c, sugar may be added to the cream and milk mixture. In embodiments, at step S100d, salt may be added to the mixture. In embodiments, at step S100e, the mixture may be churned and cooled to provide the gelato for the gelato layer 12. In embodiments, step S100e may be implemented using an ice cream or gelato machine.

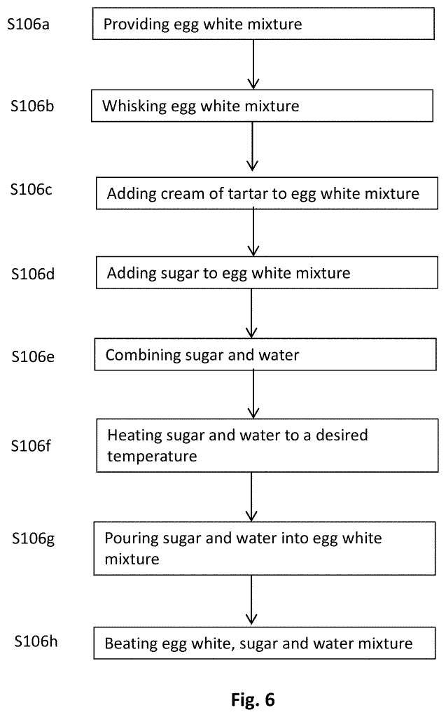

FIG. 6 illustrates a flowchart illustrating exemplary steps for making the meringue in step S106. In embodiments, at step S106a, the whites of serval eggs are combined into an egg white mixture. In embodiments, at step S106b, the egg white mixture is whisked to incorporate air into the egg white mixture. In embodiments, at step S106c, cream of tartar is added to the whisked egg whites. In embodiments, at step 106d, sugar is added to the egg white mixture. In embodiments, at step S106e, sugar is combined with water. In embodiments, at step S106f, the sugar and water are heated to a predetermined temperature. In embodiments, at step S106g, the sugar and water mixture may be poured into the egg white mixture and beaten for a period of time to provide a desired consistency for the meringue used in the meringue layer 14. It is noted that the sugar and water mixture may be prepared prior to, at the same time as, or after preparation of the egg white mixture such that step S106e and/or 106f may take place prior to, at the same time as, or after step S106a. Step S106e and/or 106f may take place prior to, at the same time as, or after any of the steps 106b-106d.

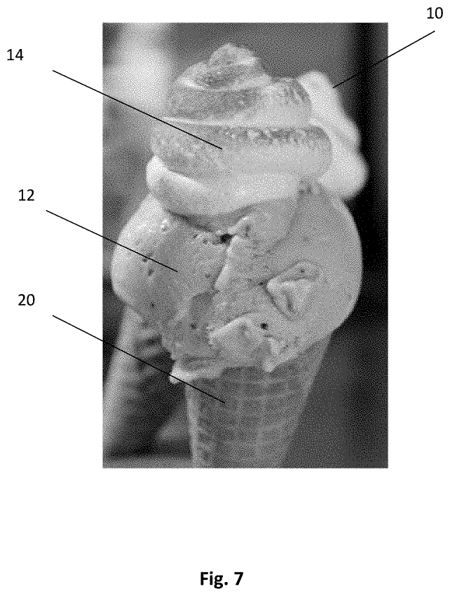

In embodiments, the frozen dessert 10 need not be packaged in container 1 and stored. FIG. 7 illustrates an embodiment in which the frozen dessert 10 is provided on an ice cream cone 20. As can be seen in FIG. 7, in embodiments, the gelato layer 12 may be deposited into the cone 20 and the meringue layer 14 merely deposited on top and torched or heated. In this embodiment, there may be no need to use the blast chiller or to store the cone 20 in a storage freezer since cones are typically consumed right away. In embodiments, the blast chiller and storage freezer may be used to make and store the dessert of FIG. 7.

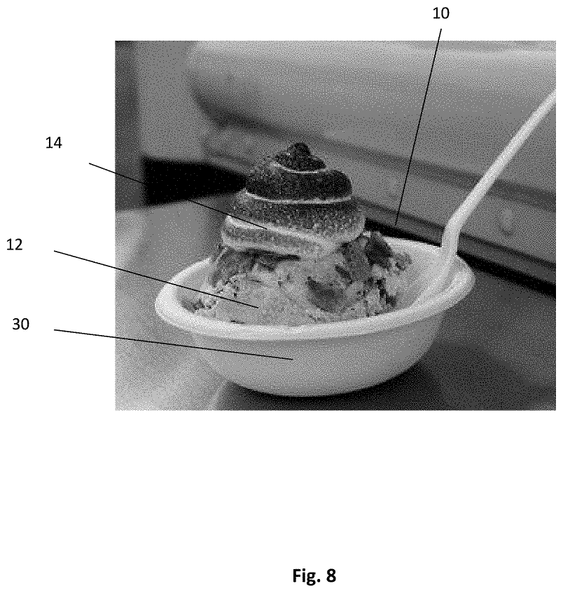

In another embodiment, the frozen dessert 10 may be served in a cup 30, such as that illustrated in FIG. 8. In embodiments such as this, the gelato layer 12 may be placed in the cup and the meringue may just be added on top to provide the meringue layer 14 and then torched or otherwise heated. In this embodiment, again, there may be no need to use the blast chiller or storage freezer since the dessert 10 is typically consumed immediately after preparation. In embodiments, the blast chiller and storage filter may be used to make and store the dessert 10 of FIG. 8.

In embodiments, the gelato layer 12 may be replaced by a baked good, or goods, such as cookie(s), cake(s) or brownie(s), to name a few. In an embodiment such as this the blast chiller and storage freezer, and the steps related thereto may not be necessary. In embodiments, the blast chiller and/or the storage freezer may still be used.

Although the present invention has been described in relation to particular embodiments thereof, many other variations and modifications and other uses will become apparent to those skilled in the art. It is preferred, therefore, that the present invention be limited not by the specific disclosure herein.

Now that embodiments of the present invention have been shown and described in detail, various modifications and improvements thereon can become readily apparent to those skilled in the art. Accordingly, the exemplary embodiments of the present invention, as set forth above, are intended to be illustrative, not limiting. The spirit and scope of the present invention is to be construed broadly.

What is claimed is:

1. A method of making and packaging a frozen dessert comprises steps of:
making gelato for a gelato layer of the frozen dessert;
adding the gelato to a container;
placing the container and gelato in a blast chiller;
making meringue for a meringue layer of the frozen dessert;
adding the meringue layer on top of the gelato layer in the container; and
heating a top surface of the meringue layer.

2. The method of claim 2, further comprising steps of:
adding a lid to the container after the heating step; and
placing the container with the lid in a storage freezer.

3. The method of claim 1, wherein the step of making gelato further comprises steps of:
combining a flavoring agent with cream;
blending a stabilizer and milk into the cream;
adding sugar to the stabilizer, cream and milk mixture;
adding salt to the stabilizer, cream and milk mixture; and
churning and cooling the stabilizer, cream and milk mixture.

4. The method of claim 3, wherein the flavoring agent includes a plurality of vanilla bean pods.

5. The method of claim 3, further comprising a step of heating the flavoring agent and cream prior to the step of blending the stabilizer and milk into the cream.

6. The method of claim 3, wherein the step of churning and cooling takes place in an ice cream machine.

7. The method of claim 1, wherein the step of making meringue further comprises:
combining a plurality of egg whites into an egg white mixture;
whisking the egg white mixture;
adding cream of tartar to the whisked egg white mixture;
adding sugar to the whisked egg white mixture;
combining sugar with an amount of water;
heating the sugar and water mixture to a desired temperature;
pouring the heated sugar and water mixture into the whisked egg white mixture; and
beating the resulting mixture to a desired consistency.

8. The method of claim 7, wherein the step of combining sugar with the amount of water takes place before the step of combining the plurality of egg whites into the egg white mixture.

9. The method of claim 7, wherein the step of combining sugar with the amount of water takes place at the same time as the step of combining the plurality of egg whites into the egg white mixture

10. The method of claim 7, wherein the step of combining sugar with the amount of water takes place before the steps of whisking, adding cream of tartar and adding sugar.

11. The method of claim 7, wherein the step of combining sugar with the amount of water takes place at the same time as at least one of the steps of whisking, adding cream of tartar and adding sugar.

12. The method of claim 7, wherein the step of combining sugar with an amount of water takes place between at least two of the steps of whisking, adding cream of tartar and adding sugar.

13. The method of claim 7, wherein the steps of combining sugar with an amount of water and heating the sugar and water mixture take place before the step of combining the plurality of egg whites into an egg white mixture.

14. The method of claim 7, wherein the steps of combining sugar with an amount of water and heating the sugar and water mixture take place at the same time as the step of combining the plurality of egg whites into an egg white mixture.

15. The method of claim 7, wherein the steps of combining sugar with an amount of water and heating the sugar and water mixture take place before the steps of whisking, adding cream of tartar and adding sugar.

16. The method of claim 7, wherein the steps of combining sugar with an amount of water and heating the sugar and water mixture take place at the same time as at least one of the steps of whisking, adding cream of tartar and adding sugar.

17. The method of claim 7, wherein the steps of combining sugar with an amount of water and heating the sugar and water mixture take place in between one or more of the steps of whisking, adding cream of tartar and adding sugar.

18. A frozen dessert comprising:
a gelato layer; and
a meringue layer positioned on top of the gelato layer, wherein a top surface of the meringue layer is heated to harden and char the top surface.

19. The frozen dessert of claim 18 wherein the meringue layer comprises Italian meringue.
